(19) United States
(12) Patent Application Publication
(10) Pub. No.: US 2010/0327034 A1
(43) Pub. Date: Dec. 30, 2010

(54) ARRANGEMENT FOR HOLDING BAGS ON A BICYCLE

(76) Inventor: Darius Matthew Hajiani, Berlin (DE)

Correspondence Address: PAI PATENT & TRADEMARK LAW FIRM, 1001 FOURTH AVENUE, SUITE 3200, SEATTLE, WA, 98154, US

(21) Appl. No.: 12/746,763

(22) PCT Filed: Dec. 8, 2008
(86) PCT No.: PCT/EP2008/010391

§ 371 Date: Sep. 3, 2010

(30) Foreign Application Priority Data
Dec. 7, 2007 (DE) 102007059219.3

(51) Int. Cl. B62J 11/00

(52) U.S. Cl. 224/441

(57) ABSTRACT

The invention relates to an arrangement for hanging bags on a bicycle (124, 127), wherein the arrangement has at least one plate-like element (61), fastening means (121) for fastening the plate-like element (61) to the bicycle (124, 127) such that, in a fastened state, the plate-like element (61) extends from the top downwards to the side of a wheel (125) of the bicycle (124, 127), and holding means (5) for holding a bag, wherein the holding means (5) are arranged in the region of the upper end of the plate-like element (61) or thereabove. The plate-like element (61) is combined with a spacer (128) which is formed thereon and/or is arranged thereon and, in the fastened state, is located on the inner side, which faces the wheel (125), of the plate-like element (61) such that an outer surface of the plate-like element (61) on that side of the plate-like element (61) which lies opposite the inner side is at a smaller distance from frame parts (124) of the bicycle (124, 127) in the upper half of the vertical longitudinal extent of the plate-like element (61) than in the lower half. The bag is hung on the holding means at a single hanging point. However, the inclination of the plate-like element (61) prevents or damps swinging of the bag resting on the plate-like element (61).

The invention relates to an arrangement for holding bags on a bicycle, and to a method of mounting bags on a bicycle.

Here, the term “bags” is used to mean in principle any containers which for their part can receive objects and can be hung from an object such as a material projection, hook or knob such that the objects received therein do not fall out. The invention is particularly advantageous for shopping bags such as carrier bags.

For bicycles, various kinds of construction are known which can be arranged on and secured to a standard baggage carrier mounted on the upper side of the rear wheel. Possible examples are bicycle bags which are arranged on one side or both sides of the front or rear wheel, with a pannier-type connection of the two bags lying on the baggage carrier.

Constructions of this kind are relatively complicated to manufacture, and in some cases have to be adapted specifically to the dimensions of a particular bicycle or baggage carrier, and some are sold to bicycle users at very high prices. As with other expensive attachments on bicycles, special measures have to be taken to prevent theft, or else the risk of a painful loss thereof has to be accepted. If for example, after parking the bicycle, users takes the bicycle bags with them into a shop, they are restricted in their freedom of movement by the volume and weight of the bags.

Moreover, various special baggage carriers for bicycles are known which makes it easier to transport bags which have no dimensional stability than with a standard baggage carrier which is composed of rods. In these cases, however, the bags are placed on the baggage carrier. The bags have to be secured against falling off, for example by tensioning belts. Moreover, the overall center of gravity of the bicycle and load is raised, which reduces stability when riding.

It is an object of the present invention to specify an arrangement for holding bags on a bicycle and a corresponding method such that the overall center of gravity of the bicycle and the load is as far as possible not raised in relation to the center of gravity of the bicycle by itself. Moreover, the parts required for the arrangement should be as lightweight as possible, be simple and inexpensive to manufacture, and as far as possible be capable of being secured to the bicycle in a simple manner.

It is proposed to arrange a protective element, which may comprise one or more parts, to the side of a wheel of the bicycle. The term “to the side of the wheel” is used to mean that the protective element is located in a direction perpendicular to the plane of rotation of the wheel, with the term “plane of rotation” being used to mean the circular surface over which, during rotation of the wheel, rotating parts in the center plane of the wheel pass. Here, part of the protective element may extend beyond the edge of the plane of rotation, for example upward to the level of a baggage carrier arranged above the rear wheel of the bicycle.

The protective element prevents bags that are arranged laterally on the side remote from the wheel from coming into contact with the rotating wheel. In the case of a spoked wheel, the protective element may thus be called a spoke guard. Moreover, the protective element prevents contact with other parts such as a gear system arranged to the side of the wheel.

The protective element may for example be a rod construction which is secured to frame parts of the bicycle. In common with most struts or rods which are already present as part of the bicycle frame, a rod construction of this kind may divide up and reduce the size of the free spaces between the frame parts such that the bag can no longer come into contact with the wheel.

It is, however, preferred for the protective element to be a plate-like element. The term “plate-like element” is used to mean an object which has a surface extending approximately in a plane, but with the longitudinal extent of the plane in two mutually perpendicular directions being very much greater than the thickness of the object. Here, the surface may be interrupted once or a plurality of times, extend in a different direction in certain regions (for example having a protuberance or cutout), be reinforced (for example by webs or ribs) or in another way deviate from the ideal shape of a planar plane-parallel plate. In particular, it is also possible for the thickness of the plate-like element to vary. For example, in the mounted condition of the plate-like element, the thickness is smaller at the upper end than at least in a partial region of the lower half of the plate-like element. More detail on this will be given below.

In a particular embodiment, the plate-like element may be capable of being folded or rolled up, such that it is a simple matter to remove it from the bicycle and transport it when it is not in use.

The term “frame of the bicycle” is used to mean all those parts which do not rotate with the two wheels when the bicycle is in motion but are of fixed construction. These include in particular bars, rods, struts, all of which are conventionally made of metal and form the actual carrying frame of the bicycle, but also attached parts which are fixedly mounted thereon, such as a baggage carrier with a baggage support surface above the rear wheel, and the additional supports used to secure the baggage carrier, in particular a support joined to the hub of the rear wheel.

A support of this kind, and the conventionally provided frame parts in the region of the rear wheel, are not however sufficient to prevent mechanical contact between the wheel and a bag to the side of the wheel. For this reason, the protective element is additionally provided. Reference will repeatedly be made below to the arrangement of the plate-like element, in particular to how the plate-like element can be secured to the bicycle frame and where it is positioned. Here, the plate-like element may in each case be replaced by another type of protective element, unless specific features of the shape of a plate-like element are being discussed.

The arrangement according to the invention for holding bags on a bicycle has, in addition to the plate-like element (or other protective element), securing means for securing the plate-like element to the bicycle, the securing means being constructed such that in a secured condition the plate-like element extends to the side of a wheel of the bicycle from the top downward. The term “from the top downward” means that the longitudinal extent of the plate-like element does not extend perpendicular to the plane of rotation of the wheel. The wheel to the side whereof the plate-like element extends is preferably the rear wheel of a bicycle. This has the advantage that the bag which is arranged to the side outside the protective element is not arranged on the steerable wheel of the bicycle. The stability of the bicycle, including the load, when riding is greater if the bag is arranged on the rear wheel.

Further, the arrangement according to the invention has holding means for holding a carrying bag, with the holding means being arranged in the region of the upper end of the plate-like element or above it. Here, the holding means are secured directly or indirectly to the bicycle frame. This makes it possible for the holding means to hold at least one bag, with the bag located to the side of the wheel on the outside of the plate-like element. The plate-like element (or, to speak more generally, the protective element) thus prevents—as mentioned above—mechanical contact between the bag and the wheel. “Indirect” securing of the holding means includes the case in which the holding means are constructed on the protective element.

Preferably, the holding means are arranged relative to the plate-like element such that a bag held by the holding means bears against the outside of the plate-like element. Here, it is preferable if an outer surface of the protective element extends from the top downward in a direction that forms an acute angle with the vertical in the secured condition. Some of the weight of the bag with the objects therein (“the load”) thus presses the protective element in the direction of the wheel. In particular when the plate-like element has an approximately planar outer surface which in the secured condition is opposed to the inner side of the plate-like element, that facing the wheel, two positive effects are produced. On the one hand the force component acting on the outer surface of the protective element prevents the bag from being set in motion in relation to the protective element. At least, swinging of the bag is damped. On the other hand, the bag presses the protective element against any frame parts that are present (such as a strut for supporting a baggage carrier), such that the protective element cannot be set in motion in relation to the bicycle either, or at least swinging or similar motions are braked. The acute angle is preferably at least 5°, for example at least 10°, and in a concrete case is for example approximately 15°. The upper limit of the acute angle is preferably around 30°. For example, the acute angle is at most 20° and in a concrete embodiment is approximately 15°, as mentioned.

In an angular range of this kind, on the one hand the overall width of the bicycle and load is not increased unnecessarily, and on the other a considerable force component of the load is exerted on the protective element. As a result of profiling and/or cutouts in the outer surface of the plate-like element, the possibilities of motion for a relative movement between the plate-like element and the load can be restricted even further.

The holding means may be for example a hook, knob or other projection which is formed by a preferably dimensionally stable material. However, it is also possible for the holding means to hold the bag in the manner of a clamp. The holding means may be integrated in the bicycle frame (for example a baggage carrier may have a projection of this kind above the rear wheel), be secured to and/or constructed on the securing means for securing the plate-like element, be secured to the bicycle frame and/or be secured to the securing means. A further possibility consists in constructing the holding means on or securing them to a material connection which connects two protective elements to one another. These two protective elements are arranged on opposing sides of the wheel, with the connection extending for example through the loading surface of the baggage carrier arranged above the wheel. In each case, it is preferable for the holding means to be constructed such that the bag (or where appropriate each bag) is hung from a single hanging point. Unlike pannier bags which are conventionally fixed to bicycles at a plurality of points on the bicycle, the bag can thus be hung from the bicycle substantially more simply. On the other hand, however, the bag may hence perform a swinging movement, or swing back and forth, during travel of the bicycle.

Yet another preferred possibility consists in the plate-like element having in the region of its upper end a projection which is the holding means or is part of the holding means. The plate-like element and the projection are in this case constructed in one piece. The projection may for example be a hook-shaped projection and/or a downwardly protruding projection. It is also possible to construct a plurality of projections on the plate-like element.

The securing means for securing the plate-like element may be a one-piece construction or a combination of parts which are not connected to one another and are only connected to one another in the secured condition, by way of the plate-like element. For example, part of the securing means may serve to secure the plate-like element to a baggage carrier (for example the baggage carrier on the rear wheel of the bicycle) that is arranged above the wheel. For example, the plate-like element may have in the region of its upper end a grasping device for grasping a bicycle frame part, in which the grasping device is the securing means or part of the securing means. In this case the plate-like element and the grasping device are constructed in one piece. Optionally, moreover, the projection already mentioned above may also be constructed in one piece with the plate-like element. The grasping device may for example be a device having two mutually movable elements which in the mounted condition grasp completely or almost completely around a frame part of the bicycle, for example. In particular, it is possible to enable mounting or to release grasping of the frame part by actuating the lower movable element.

A second part of the securing means can then serve to secure the plate-like element to frame parts to the side of the wheel in a region lower down, or at least to restrict the freedom of movement of the plate-like element in relation to the frame in this region. In particular cables, belts, strips of material or moldings (in particular plastics moldings) may serve for hanging the plate-like element. For example, a plastics part may be connected force-fittingly and/or form-fittingly to the plate-like element at the top of the plate-like element. This plastics molding may take the form of a clip on a free end, and may be clamped to the longitudinal strut of a baggage carrier with elastic deformation.

The securing means may be constructed on the protective element (in particular the plate-like element) for example as a clamp or hook-and-burr closure strip. This in particular serves to secure the protective element to the side of a baggage carrier above the wheel.

To secure a region of the plate-like element that is lower down to the side of the wheel, there is preferred an elongate elastic element which has for example a respective hook at the opposing ends, in the manner of a chest expander, such that the hooks can be hooked to frame parts of the bicycle when the elongate element is put under tension. During this, at least a section of the elongate elastic element extends for example through an opening in the plate-like element or is fixedly connected to a region of the plate-like element.

As already mentioned with reference to an exemplary embodiment, the arrangement may have two plate-like elements (or, to speak more generally, protective elements) which in the secured condition are arranged on mutually opposing sides of the wheel. This makes it possible to arrange a load on the opposing sides, in each case outside the plate-like elements. Here, holding means for holding in each case at least one bag are preferably provided for each side of the wheel. For example, a first holding means is arranged on the one side of the wheel and above the wheel, and a second holding means is arranged on the other side of the wheel and above the wheel. This provides the possibility, depending on the concrete embodiment of the holding means, of hanging the bag to be arranged on one side of the wheel not only from the holding means on that same side but as an alternative or in addition to hang it from the holding means on the other side of the wheel. Loops, cutouts or lugs on the bag from which the bag may be hung may thus be hung for example on the other side of the wheel, such that part of the bag or hanging part extends beyond the center plane of the wheel to the other side, on which the actual load is arranged. Depending on the type of bag and the way in which it is hung (for example with long lugs or a loop), it is thus possible to choose from which holding means the bag is hung. This makes it possible to adjust the height above the ground at which the lowest point of the load is arranged. In particular, it is possible in this way to prevent the load from being too close to the ground and possibly coming into scuffing contact with the ground. However, it is also possible to prevent the load from extending too far down beyond the lower edge of the plate-like element. In a case of this kind, despite the presence of the protective element, it might be possible for mechanical contact with the wheel to occur.

It is also possible for the holding means to be part of a connection device which connects to one another two plate-like elements arranged on opposing sides of the wheel. This is also true of the case in which the securing means are not part of the connection device or are connected thereto.

In a concrete embodiment, the plate-like element is connected to the holding means by way of at least part of the securing means. For example, the plate-like element is hung from a baggage carrier arranged above the wheel, and the holding means are also arranged on the baggage carrier or constructed as an integral part of the baggage carrier. However, it is also possible for at least part of the securing means to be shaped out of the holding means. For example, a hook or projection from which at least one bag may be hung may be constructed at the upper end of a hanging part for hanging the plate-like element.

In particular in order to achieve the acute angle, which has already been described above, between the course of the outer surface of the plate-like element and the vertical, in a preferred embodiment the plate-like element is combined with a spacer which is formed out of the element and/or is secured thereto. In the secured condition, the spacer is located on the inner side of the plate-like element, that facing the wheel. In this way, it is possible for an outer surface of the plate-like element on that side of the plate-like element that is opposed to the inner side to have a smaller spacing from frame parts of the vehicle in the upper half of the vertical longitudinal extent of the plate-like element than in the lower half. When these frame parts are in an approximately vertical plane this results in the acute angle already described. In particular if the bicycle has a gear system with chain wheels secured to the side of the wheel, the spacer can prevent contact between the plate-like element and the chain wheels or other parts of a gear system. The spacer is therefore preferably dimensioned such that it keeps the plate-like element at the height of the gear system at a spacing from the wheel and the frame that prevents contact between the plate-like element and the gear system.

The spacer need not be fixedly connected to the plate-like element. Rather, it is also possible to secure the spacer to frame parts of the bicycle separately. It is however preferred for the spacer to be shaped out of the plate-like element or secured thereto. For example, the plate-like element made from a dimensionally stable material is profiled or reinforced at certain points such that the spacer projects out of the otherwise substantially planar course of the plate-like element in the direction of the wheel. However, it is also possible for the plate-like element only to have a thickness which increases from the top downward. For example, the outer surfaces of the plate-like element may extend both on the inside and on the outside along a plane but the surface material may be at a spacing which increases from the top downward, with it being possible for the hollow space between the surface material to have supports for supporting the two outer surfaces in relation to one another. A construction of this kind may for example be constructed as a webbed plate whereof the length of the webs increases from the top downward, with the length of the webs being measured in the direction of the thickness of the webbed plate. The “webs” connect the materials to the opposing surfaces of the plate.

To enable the size of the acute angle mentioned above to be adjusted, the spacer may be adjustable and/or the arrangement comprising the plate-like element and the spacer may be adjustable. For example, the thickness of the spacer—that is the dimension between the plate-like element and the frame of the bicycle—may be adjustable. It is thus possible for example to mount the spacer fixedly in one region of the plate-like element but to adjust a further point of contact between the spacer and the plate-like element and hence to vary the thickness. As an alternative or in addition, the vertical position of the spacer in relation to the bicycle may be adjustable such that the acute angle is adjusted in a manner dependent thereon.

If the spacer is located in a higher position on the frame, the acute angle is larger, and vice versa if the plate-like element is moreover secured to the frame at the top.

It is also possible for the spacer for the plate-like element to be formed from separate pieces.

However, a spacer may also be provided on other types of protective element. For example, a protective element which is constructed from rods or other elongate elements may have a long rod, which extends from the top downward, and a short transverse rod which is mounted in the bottom third of the long rod. If the transverse rod is arranged at the bottom end of the long rod a T-shaped profile is achieved. The transverse rod serves as a spacer and may be connected at its free end, for example by way of a part of the securing means, to the frame parts which are arranged to the side of the wheel. Preferably, in the secured condition the spacer is located in the lower half of the vertical longitudinal extent of the plate-like element. In particular, the spacer may be located in the bottom third of the vertical longitudinal extent. It is also possible for more than one such rod construction to be arranged on the same side of the wheel.

If the plate-like element is constructed and secured to the bicycle such that the spacer is located above the axis of rotation of the wheel, then with a conventional design of the bicycle frame, with two struts which converge in a V shape from the top toward the axis of the wheel, the spacer will bear against these two struts, such that stable seating is achieved. Typically, the strut which is at the front, as seen in the direction of travel, is a strut of a carrying frame of a bicycle and the other strut, the one extending from the axis toward the top rear, is a support strut of a bicycle baggage carrier above the rear wheel.

So that the vertical position of the spacer can be adjusted in relation to the wheel, preferably one or both of the following features is proposed:
Securing of the plate-like element in the region of the upper end thereof is adjustable longitudinally and/or is elastic in such a way that this allows the position of the spacer secured to the plate-like element to be adjusted. With an elastic construction, the position can be adjusted in that further securing means secure the plate-like element to frame parts of the bicycle in the middle or lower region of the plate-like element, and the elastic securing is accordingly tensioned to a greater or lesser extent. The elastic securing may, however, still bear some of the weight of the plate-like element. In particular, it fixes the plate-like element in the upper region thereof.
The spacer is mounted on the plate-like element. Its position in relation to the plate-like element is adjustable, however. For example, the spacer may have projections which can be used optionally in recesses in the plate-like element which are at higher or lower positions, in order to secure the spacer to the plate-like element.

In a particular embodiment of the holding means, the latter have an elastic ring on which at least one respective clamp-like projection is arranged on opposing sides. The spacing between the clamp-like projections which are opposed in this way is of a size such that it is smaller than the spacing between two frame parts (in particular the outer longitudinal struts on the load surface of a baggage carrier) which are spaced from one another transversely to the longitudinal direction of the bicycle and which extend in the longitudinal direction, with the elastic ring being deformable such that the spacing between the opposing projections increases. In this way, the elastic ring may be deformed such that the spacing between the projections is increased, for example being placed on the load surface of a baggage carrier, and clamps the baggage carrier fixedly to the frame parts when the tension is relaxed.

At least one projection from which bags may be hung may be located in each case at the lateral ends of this holding device.

Preferably, the plate-like element has a length of at least 30.5 cm in the vertical direction. 30.5 cm corresponds to half the diameter of a 24″ wheel. In particular, in the secured condition the plate-like element is approximately 45 cm long and/or approximately 45 cm wide at its widest point (that is, in the direction of travel of the bicycle). The dimensions depend on the shape of the plate-like element. The thickness (in a direction transverse to the plane of rotation of the wheel) is, for example, approximately 5 cm at the spacer and is for example in the region of approximately 4 cm to approximately 6 cm.

The invention further relates to a method for mounting bags on a bicycle, in which a plate-like element or another protective element is secured to the bicycle such that the plate-like element extends to the side of a wheel of the bicycle from the top downward, and in which a bag is hung from the frame of the bicycle such that the bag bears against an outer surface of the plate-like element which is remote from the wheel.

It is possible for two plate-like elements to be arranged on mutually opposing sides of the wheel to enable bags to be hung on opposing sides.

The plate-like element may be hung from a load carrier which is arranged above the wheel.

In particular, the plate-like element is secured to frame parts of the bicycle which are arranged to the side of the wheel.

The plate-like element is for example connected to the frame parts by way of at least one elongate elastic element.

The plate-like element may be arranged to the side of the wheel such that an approximately planar outer surface of the plate-like element whereof the surface normal is directed away from the wheel is increasingly distant from the plane of rotation of the wheel from the top downward. A plate-like element prevents contact with chain wheels or gear wheels to the side of the wheel, and contact with spokes.

In relation to the advantages of the method, the reader is referred to the description of the arrangement and to the text below.

A plate-like element may be made of various materials, for example wood, plastics, or composite material (such as fiber-reinforced plastics). Preferably, the plate-like element is made from a material that has a lower density than metal (in particular a density that is less than half the density of commercially available steel or aluminum for building bicycles). It is also preferred for the plate-like element to be made of water-resistant material. For example, the plate-like element may be made of paper material or card, and the surface may be impregnated and/or coated. All the statements made here in relation to the material of the plate-like element preferably also apply to the other parts of the arrangement according to the invention, it being possible to use different materials for the different parts of the arrangement. For example, the plate-like element is made of a plastics material of very low density, while the securing means are made of a high-strength plastics material and/or metal, unless elastic securing parts are involved.

The use of plastics parts or another material of low density which can be manufactured at low cost makes it possible to offer the parts of the arrangement for sale at a low cost in shops. For this reason, a customer who buys an unexpectedly large number of goods may purchase the parts of the arrangement without incurring high costs and transport their purchases home by bicycle. The arrangement according to the invention may be used once or repeatedly. For example, the user of the bicycle leaves the arrangement mounted until they would like to change the appearance of their bicycle again, and disposes of the parts at that stage. For example, at least parts of the arrangement are made from biodegradable material.

If a plate-like element is used as the protective element, the outer surface may be used for a pleasing or artistic visual design. As an alternative or in addition, the outer surface may be used for advertisements. The spacer may take the form of a material region which runs in the direction of travel of the bicycle and preferably extends over almost the entire width (as seen in the direction of travel) of the plate-like element.

The arrangement according to the invention makes it possible for example to transport by bicycle up to four full bags of shopping, with the overall center of gravity comprising the bicycle and the load not substantially above the axes of rotation of the wheels.

The stability when riding is not therefore impaired. In particular if different bags bear separately against the frame on opposing sides of the same wheel by way of a respective protective element, the load may be distributed evenly on both sides.

When plate-like elements are used as protective elements, care should be taken that sufficient spacing is maintained from the bicycle pedals in order not to hamper the rider as they pedal. This is readily possible with commercially available bicycle constructions if the plate-like element is not much wider than 40 cm and the center of the plate-like element is arranged approximately at the axis of rotation of the wheel, as seen in the direction of travel.

It is not only the low center of gravity which contributes to stable behavior on riding despite the load but also the fact that, although most of the weight of the load is borne by the holding means from which the bag is hung, with a suitable construction of the protective element some of the weight also presses the load against the protective element. This prevents the load from swinging in a direction transverse in relation to the direction of travel.

If, as is preferred, the holding device is arranged on the bicycle frame such that the load surface of a baggage carrier above the wheel remains free, the baggage carrier can additionally be used for loads. For example, a further load may be clamped to the baggage carrier.

Preferred exemplary embodiments and further features of the invention will now be described with reference to the attached drawing. The individual figures in the drawing schematically show the following:

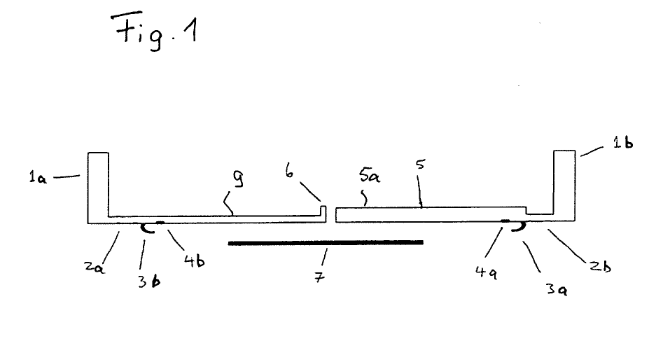

FIG. 1 shows a holding and securing device which can for example be mounted on a standard bicycle baggage carrier, in side view,

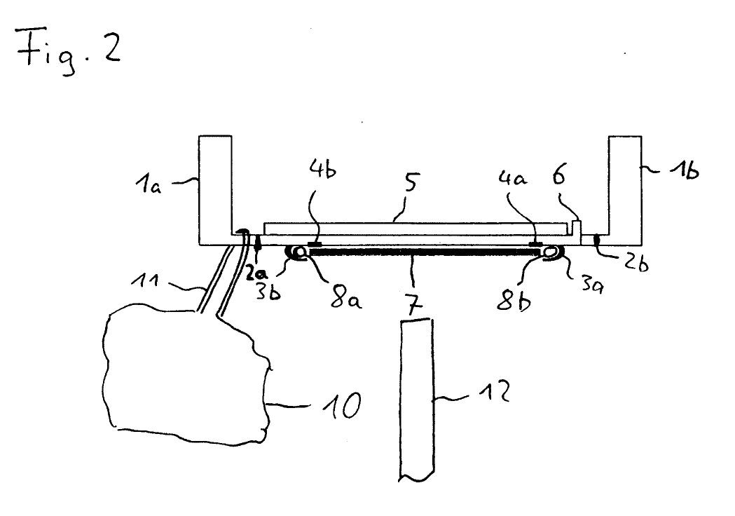

FIG. 2 shows the device according to FIG. 1 in a mounted condition;

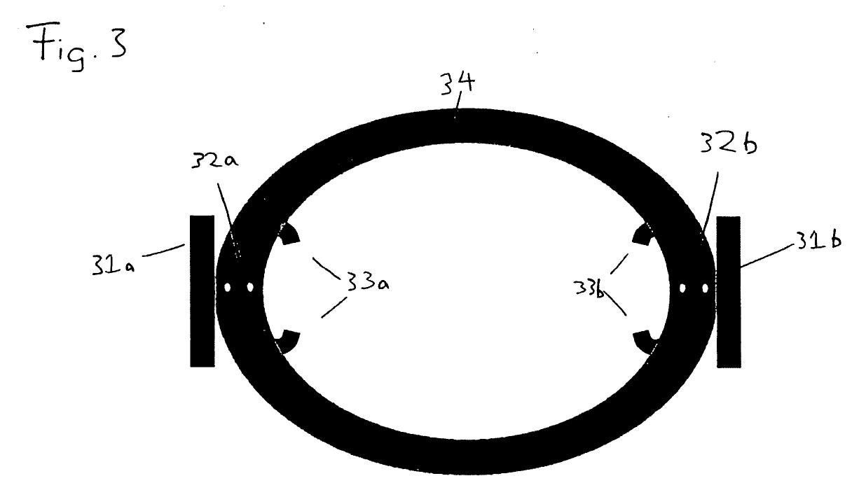

FIG. 3 shows a second embodiment of a holding and securing device, in plan view from above in the relaxed condition,

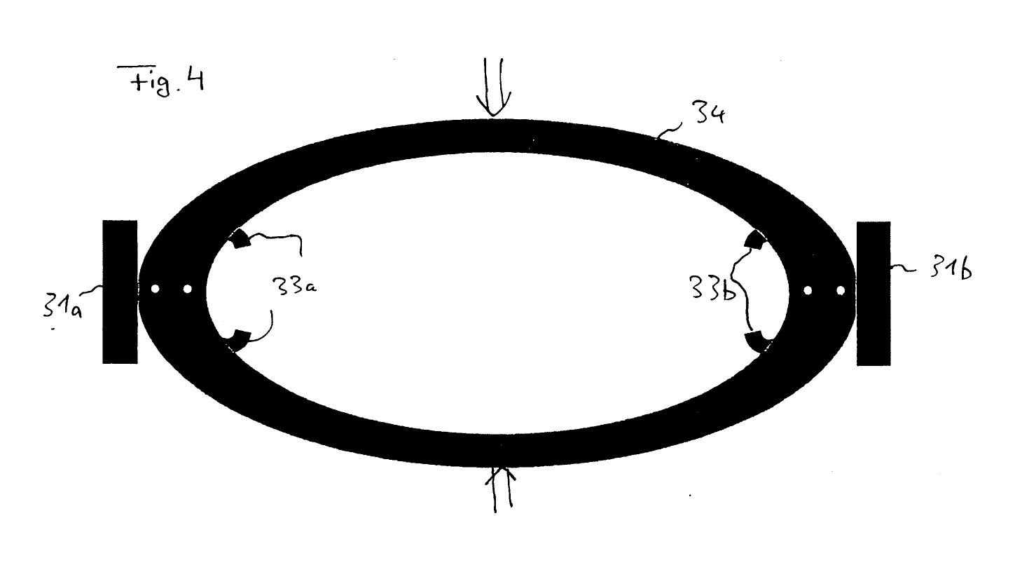

FIG. 4 shows the device according to FIG. 3, in plan view in a tensioned condition,

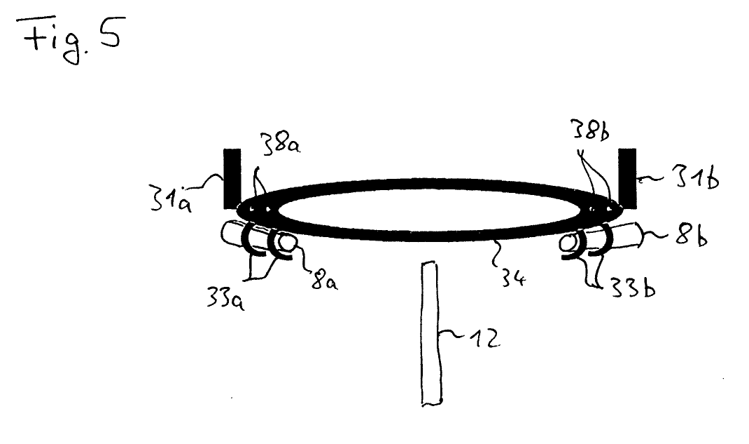

FIG. 5 shows the device according to FIG. 3 and FIG. 4, in a perspective illustration from obliquely above, in a mounted condition,

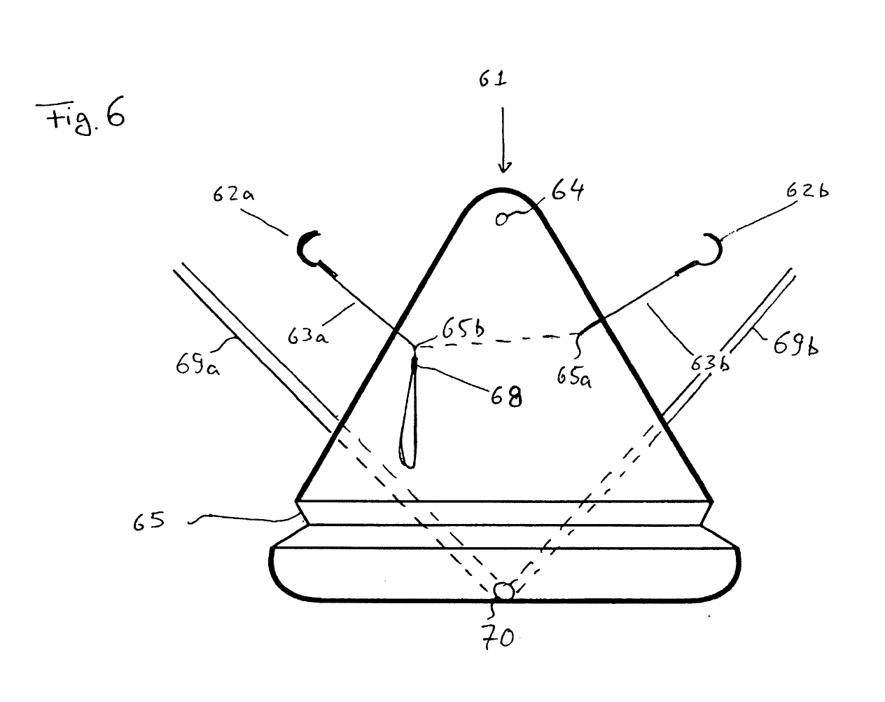

FIG. 6 shows a plate-like protective device in a view of the outside of the device,

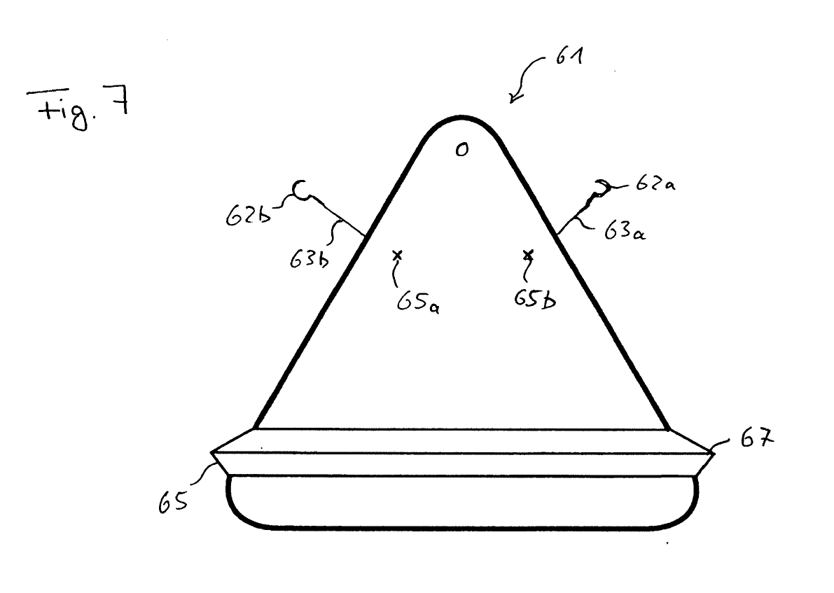

FIG. 7 shows a view of the protective device illustrated in FIG. 6, from the inside,

FIG. 8 shows a further embodiment of a protective device in an outside view,

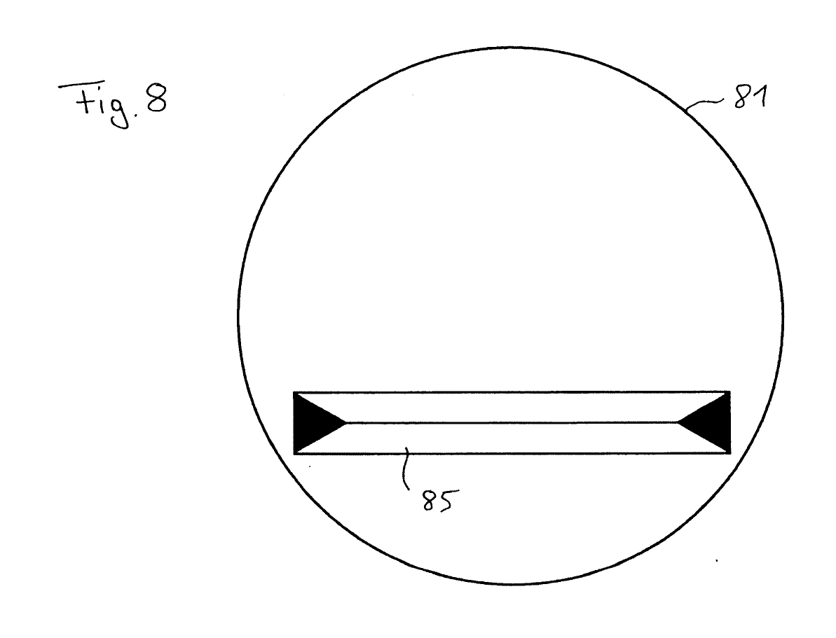

FIG. 9 shows a further embodiment of a protective device in an outside view,

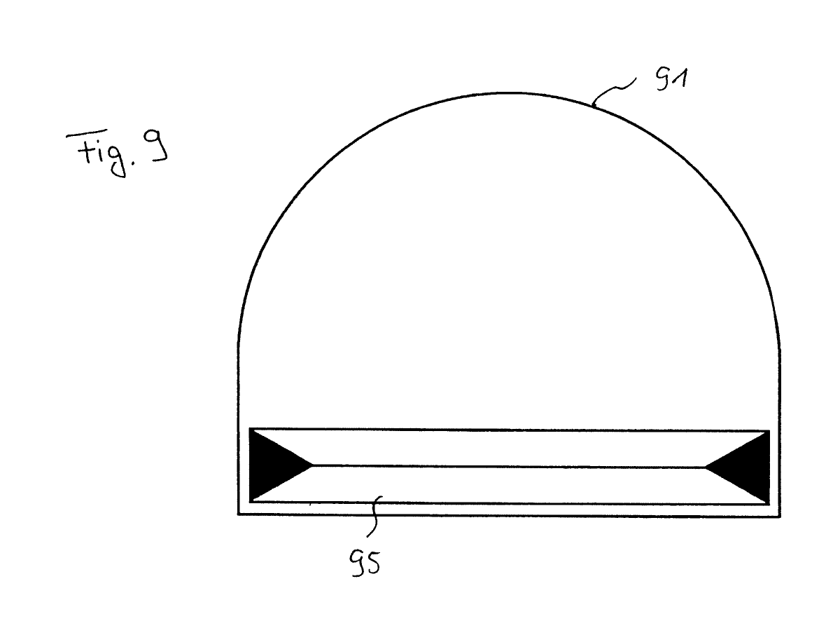

FIG. 10 shows yet another embodiment of a protective device in an outside view,

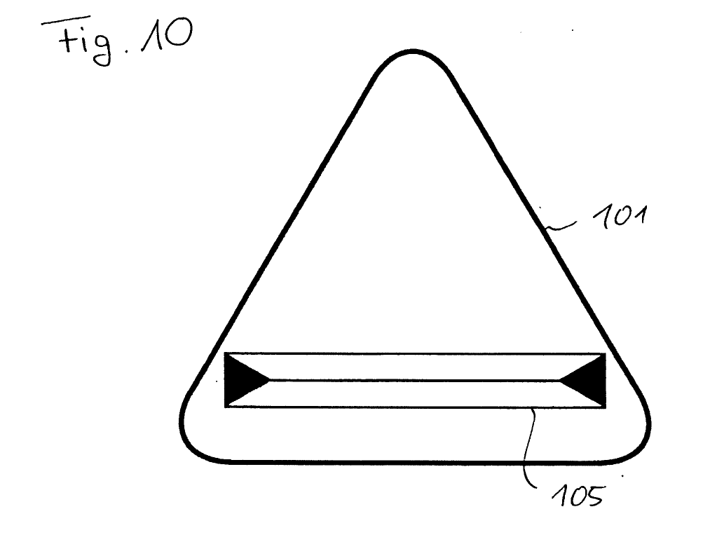

FIG. 11 shows a three-dimensional view of an arrangement having two protective devices,

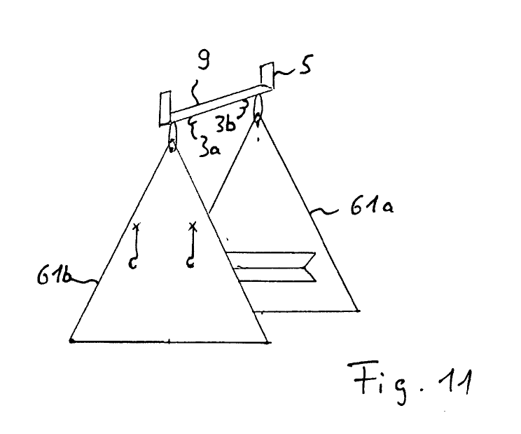

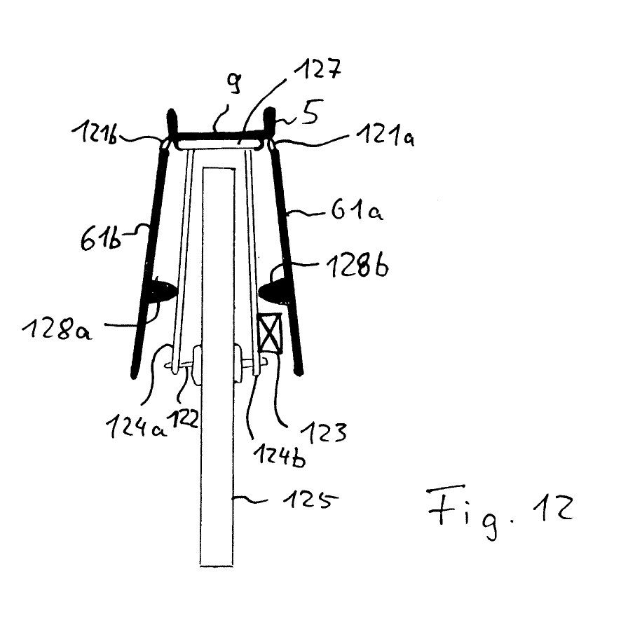

FIG. 12 shows a view of a bicycle from the rear, in which of the bicycle the rear wheel, frame parts in the region of the rear wheel and a baggage carrier are illustrated, and in which an embodiment of an arrangement according to the invention is visible,

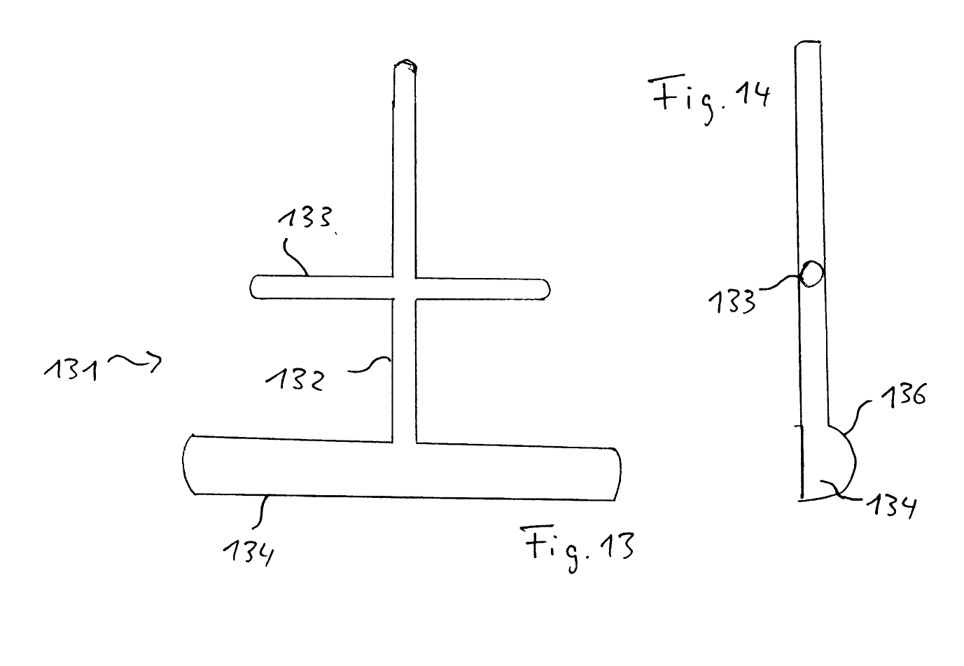

FIG. 13 shows a protective device which is not plate-like in form, in side view,

FIG. 14 shows the protective device according to FIG. 13, in profile, and

FIG. 15 shows the outside view of another embodiment of a protective device which may be used for example instead of the plate-like protective device illustrated in FIG. 12,

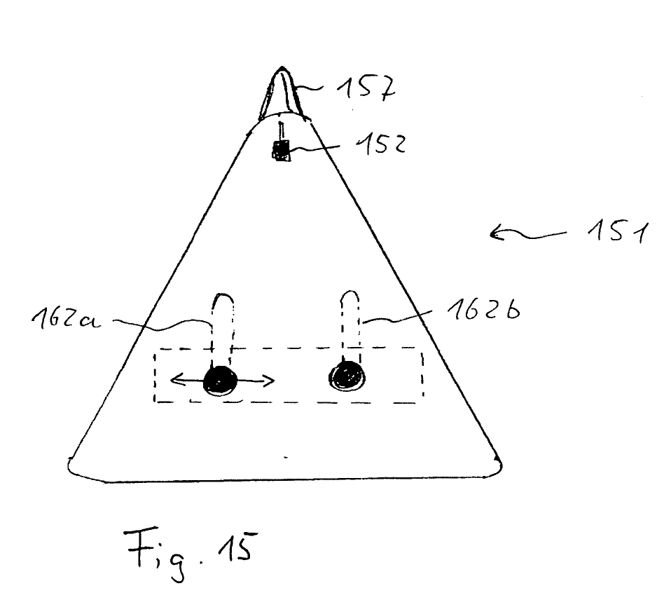

FIG. 16 shows the inside view (view of the side facing the wheel in the mounted condition) of the protective device according to FIG. 15, in a first condition,

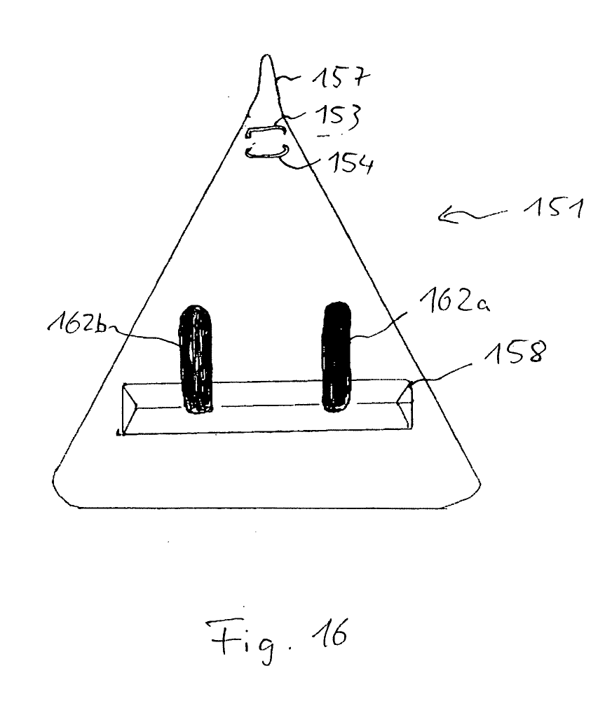

FIG. 17 shows the inside view of the protective device according to FIGS. 15 and 16 in a second condition,

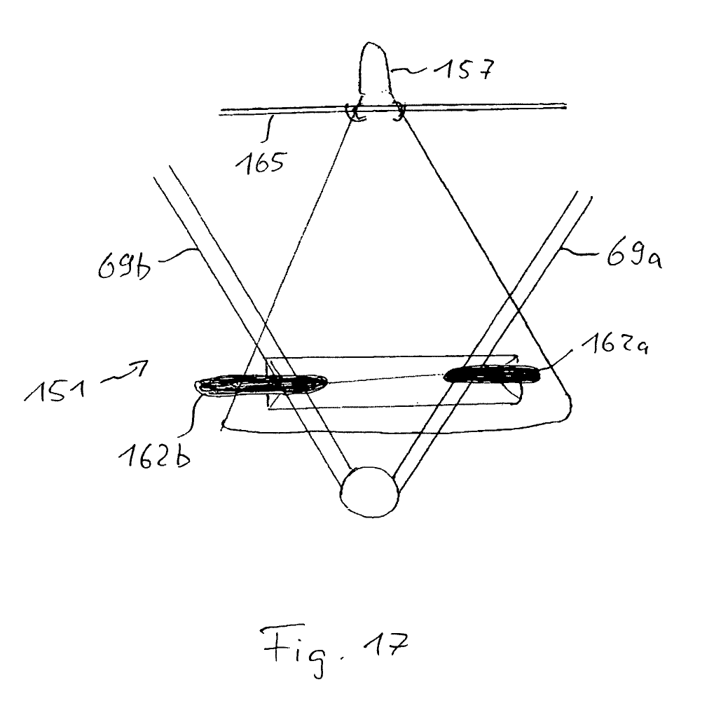

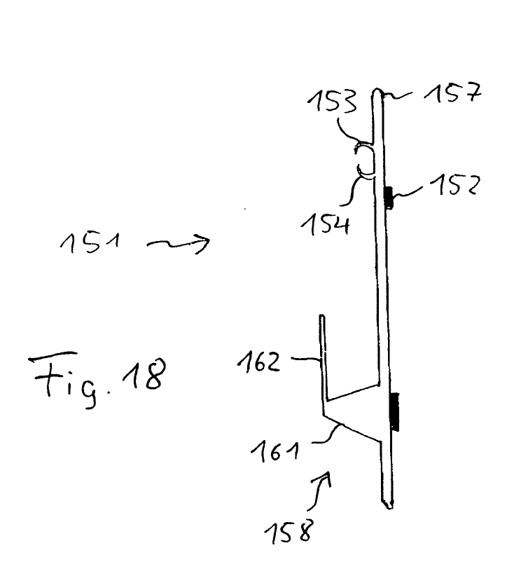

FIG. 18 shows the profile of the protective device according to FIGS. 15 to 17,

FIG. 19 shows schematically a plan view from the inside of a further embodiment of a plate-like element having a three-part spacer whereof the thickness—that is, the spacing between the plate-like element and the frame of the bicycle—is adjustable,

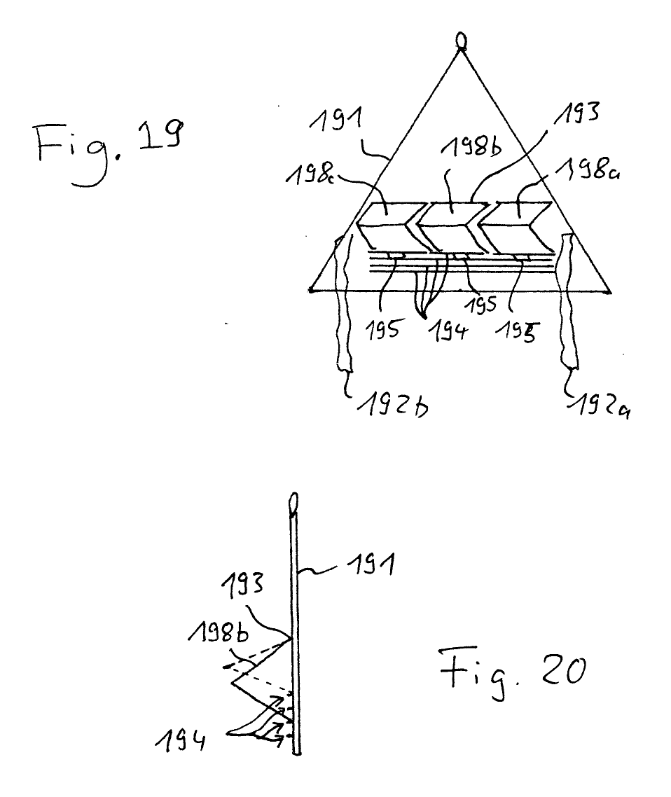

FIG. 20 shows a side view of the spacer and the plate-like element from FIG. 19,

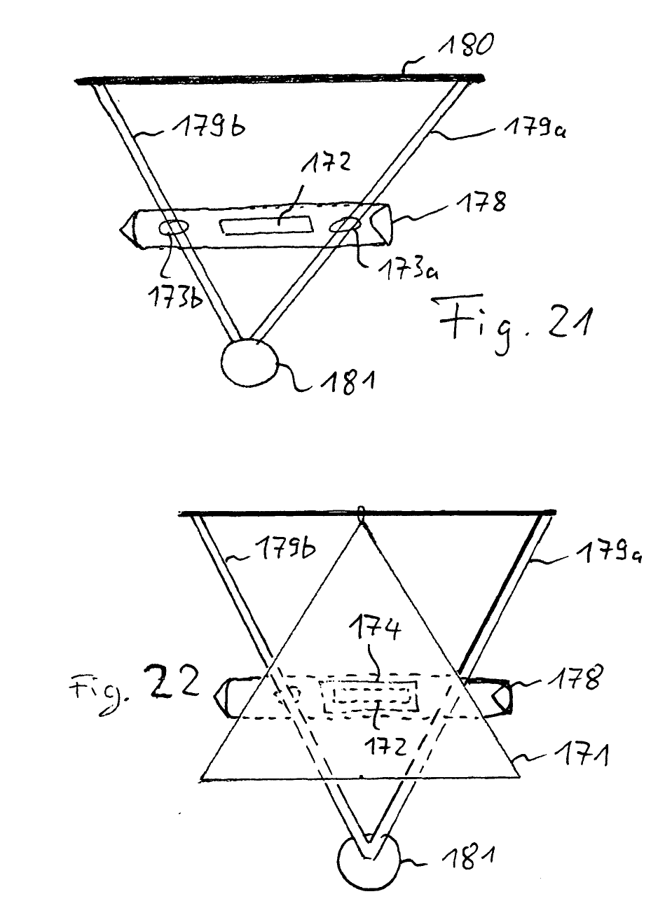

FIG. 21 shows schematically a side view of yet another embodiment of a spacer which is secured to frame parts of the bicycle separately from the associated plate-like element, and

FIG. 22 shows the spacer of FIG. 21, with the associated plate-like element mounted on the bicycle and secured to the spacer.

The device illustrated in FIG. 1 is in three parts and can be mounted on the top of the load surface of a standard bicycle baggage carrier. FIG. 2 shows the mounted condition. The cross section of a first rod 8a of the baggage carrier and a second rod 8b of the baggage carrier are visible, with the rods 8 extending perpendicular to the plane of the drawing in FIG. 2.

The part 5 of the device which is illustrated on the right in FIG. 1, although not illustrated in more detail, may be hollow in construction in its interior region 5a facing the opposing part 9, such that the free end 6 of the part 9 can be pushed through the hollow region 5a and the angled end 6 can emerge at the opposing end of the hollow region 5a, as shown in FIG. 2.

As the third part, the device has an elastic band 7 which can be secured at one end to a point 4a on the first part 5 and at its other, opposing end to a region 4b on the second part 9. For example, a respective hole is provided in the regions 4a and 4b, and the ends of the elastic band 7 are secured there, in each case by means of further securing means (not illustrated specifically), such that the elastic band 7 is placed under tension when the regions 4a, 4b are moved apart. FIG. 2 shows a condition of the elastic band 7 in which this is only tensioned to a small extent. However, if the regions 4a, 4b are further apart than illustrated in FIG. 2, the tensile force in the longitudinal direction of the elastic band 7 is greater. The device is thus held in the condition illustrated in FIG. 2—that is, the clamps 3a, 3b made respectively at the bottom, on the underside of the parts 5, 9, grasp the rods 8a, 8b from the outside and are pressed against the rods 8a, 8b by the elastic restoring forces of the elastic band 7.

As a result, the device is prevented from being unintentionally detached from the baggage carrier because of the elastic band 7.

Moreover, the parts 5, 9 each have an upwardly protruding projection 1b, 1a on their outside ends. As shown in FIG. 2, these projections 1a, 1b are located to the side, outside the rods 8a, 8b of the baggage carrier. When the lugs or loops of a bag are hung from one of the projections 1a, 1b such that the projections pass through the opening formed by the loop or lug, the bag can hang down either on the same side as the projection 1a, 1b or, if it is hung across, on the opposite side of the device. FIG. 2 schematically illustrates a bag 10 with a carrying loop 11 which is hung from the projection 1a on the left-hand side.

Further, the device may have, for example at the point designated 2a or 2b, an opening from which a protective device which is not illustrated in more detail in FIG. 2, for example a plate-like element, is hung. The protective element is then located between the bag 10 and the wheel 12 of the bicycle, illustrated schematically bottom center in FIG. 2. Further frame parts of the bicycle have been omitted from FIG. 2 for the sake of clarity.

FIG. 3 to FIG. 5 show an elastic ring 34 which in the oval shape illustrated in FIG. 3 is approximately in its relaxed condition. When the ring 34, as indicated by arrows in FIG. 4, is compressed such that the oval becomes more elongate, the ring 34 is in opposition to the elastic restoring forces. In the condition illustrated in FIG. 4, the ends of the oval which are illustrated to right and left in the figure and on which, similarly to the device in FIGS. 1 and 2, there are located hooks 33a, 33b and projections 31a, 31b, the latter protruding upward out of the plane of the drawing in FIG. 4, are at a greater spacing than in the relaxed condition of FIG. 3.

The device is thus deformed by the exertion of forces as indicated in FIG. 4, and is then placed for example on the load surface of a standard bicycle baggage carrier, then the ring 34 is allowed to relax its tension such that the clamps 33a, 33b come into contact with mutually parallel struts 8a, 8b of the baggage carrier or with other frame parts. FIG. 5 should be understood, as viewed in the direction of travel, as a schematic perspective illustration. In reality, the illustrated sections of the struts 8a, 8b extend approximately parallel to one another.

Once again, bags may be hung from the projections 31a, 31b. Further, once again there are regions 38a, 38b close to the projections 31a, 31b from which protective devices may be hung, and in the mounted condition these are located on both sides, to the side of the wheel 12 indicated in the center of FIG. 5. FIG. 11 shows two protective devices 61a, 61b which are hung a device as illustrated in FIGS. 1 and 2. The rear wheel of a bicycle and the frame parts of the bicycle arranged there may be located between the devices 61. The protective devices 61 may take the form which is illustrated in more detail in FIG. 6. In FIG. 11, parts are designated by the same reference numerals as in figures that have been described above.

FIG. 6 shows the outer surface—that is, the side remote from the wheel in the mounted condition—of a protective device 61. Further, FIG. 6 illustrates two struts 69a, 69b of the frame construction of the bicycle, which diverge from the bottom upward in a V shape and are both secured at the bottom in the region of the hub 70 of the rear wheel. The dashed portions are located behind the protective device 61. For example, FIG. 6 represents the view from the right-hand side of the bicycle, so the strut 69b is for example a strut of the carrying frame of the bicycle and the strut 69a serves for example as the support for the baggage carrier (which is not illustrated in detail in FIG. 6).

The protective device 61 is substantially plate-like, with the parallel surfaces on the inside and the outside extending approximately parallel to one another and in a plane. In this case, the plate is triangular with rounded corners. In the lower half of the device 61, however, the latter has a profiling 65 which is V-shaped in cross section, with the tip 67 of the profiling lying on the inside as illustrated in FIG. 7—that is, bearing against the struts 69a, 69b in the mounted condition. The remaining region of the inside, by contrast, does not bear against the frame construction of the bicycle, or at most does so at certain points.

The profiling 65 extends over the entire width of the device 61, approximately parallel to the direction of travel of the bicycle.

So that the device 61 can be hung at the top in the region of its upper rounded corner, the region has a through opening 64 there. Further, through openings passing through the plate-like material or securing regions are formed at the points 65a, 65b, at which a respective elastic band 63a, 63b is secured by means of a hook 62a, 62b arranged on the free end thereof.

As an alternative, the elastic band may be a single continuous elastic band which passes through the plate material at the through openings 65a, 65b and is guided along the inside of the plate, as illustrated in FIG. 6 by a dashed line. By means of a loop 68 having a fixing device, the available length of the elastic element 63a or the entire elastic element may be lengthened or shortened. In this way, the device 61 may be secured to different frame constructions of bicycles by means of the hooks 62a, 62b. In particular, the elastic elements 63a, 63b may be shorter than illustrated in FIG. 6, with the result that they can be hooked onto the struts 69a, 69b.

It is also possible to use adaptable securing means for plate-like protective devices with different lengths and securing points, for example fabric webs or dimensionally stable plastics parts for clipping onto the frame construction.

FIG. 8 shows another form of a plate-like protective device 81, which once again has in its bottom third a spacer, designated by the reference numeral 85. This is not a profiling, however, but an additional component which is fixedly connected to the surface of the plate, for example being glued with an industrial adhesive, or (if both materials are made of plastics material) welded by a thermoplastic method.

Apart from the circular shape of the plate-like element of the protective device shown in FIG. 8, further shapes are also possible, for example the semicircular shape illustrated in FIG. 9 for a device 91 also having an attached spacer 95.

As shown in FIG. 10, the triangular shape with a top corner of the device according to FIGS. 6 and 7 may also have a spacer 105 which is attached in the bottom quarter. In the case of the device 101 illustrated in FIG. 10, as in the case of the devices 81, 91 according to FIG. 8 and FIG. 9, it possible for example, similarly to what is shown in FIG. 6 and FIG. 7, for additional securing means for securing the device to the bicycle frame to be provided. Quick-release devices and/or closures such as hook-and-burr closures, hooks and clips are preferred for securing.

FIG. 12 shows a rear wheel 125 to the axis 122 whereof frame parts 124a, 124b which support a baggage carrier 127 above the wheel 125 are secured to both sides of the wheel 125.

Holding means 5, 9 (for example as described above with reference to other figures) are arranged at the top on the baggage carrier 127 and are secured to the baggage carrier 127. Secured to the holding means 5, 9 to both sides of the wheel 125 is a respective band 121a, 121b which at least partly bears the weight of a plate-like protective device 61a, 61b. The protective device 61a, 61b may be secured, for example, to the frame parts 124a, 124b in each case by way of further securing means, in a manner not illustrated in more detail.

A respective spacer 128a, 128b is constructed on the protective devices 61a, 61b, and this is arranged on the inside, facing the wheel 125, and is supported against a respective one of the frame parts 124a, 124b. On the right-hand side of the wheel 125, the position and extent of parts of a gear system 123 are illustrated schematically, but these may also lie lower down, at the level of the axis 122. It will be seen that the spacer 128b prevents contact between the protective device and the gear system 123.

The protective device 131 which is not plate-like (see FIGS. 13 and 14) is a rod construction. A first rod 132 extending vertically is crossed, approximately at its center, by a second horizontally extending rod 133. At the lower end of the first rod 132 there is a further rod 134 which extends horizontally. This lower rod 134 takes the form of a spacer 136 (as shown in FIG. 14), since it projects to the right by comparison with the rods 132, 133. The right-hand side faces the wheel in the mounted condition, such that the rod 134 is supported against frame parts of the bicycle.

FIGS. 15-18 show a further embodiment 151 of a protective device. Once again, it has a spacer 158 on the inside. At its upper end there is an upwardly protruding projection 157 from which bags can be hung. Moreover, in the region of its upper end there is a securing device for securing to frame parts, in particular a longitudinal strut of a baggage carrier. The securing device takes the form of a clamp and has an upper element 153 and a lower element 154. In the mounted condition, the elements 153, 154 grasp a frame part (see FIG. 17) 165, the lower element from below and the upper element from above. The lower element 154 is movable in relation to the upper element 153—that is, grasping can be closed and opened. To actuate the lower element 154, a handle or other actuation element 152 which is actuable from the outside may be provided. The actuation element 152 may be integrated in the plate-like region of the protective device 151 so that it does not collide with hung bags and become actuated unintentionally. The actuation element is for example in the form of a slidable knob.

The spacer 158 is of a particular construction. This construction may also be provided not only in the case of the specific protective device illustrated in FIG. 15 to FIG. 18 but also in the case of other embodiments.

The spacer 158, like other embodiments of spacers, has a region 161 which projects on the inside and provides the spacing function. However, on the projecting region there are two pivotal elements 162a, 162b which can each be pivoted about an axis of rotation which runs approximately perpendicular to the surface of the protective device 151. Here, the elements 162 are each attached at that point on the projecting region 161 which protrudes the furthest in the direction of the wheel. When the protective device 151 is mounted, the pivotal elements 162 are located first in a position with their free ends pointing upward (FIG. 16). Then the elements 162 are pivoted such that they each reach behind a rod-shaped frame part 69a, 69b of the bicycle (FIG. 17). The frame parts 69 are for example the frame parts mentioned above in the description of FIG. 6. The pivotal position in the mounted position may vary, depending on the bicycle in question. In this way, the protective device can be adapted to the construction of the bicycle.

It is further possible for the positions at which the elements 162 are attached to the material of the protective device such that they are visualizable. This is indicated in FIG. 15 by two arrows in the horizontal direction at the point where the element 162a is attached. However, it is also possible to adjust the positions of both elements.

In a deviation from the embodiment described here, a protective element may also have only one pivotal element, or have more than two such elements.

It is also possible for at least one pivotal element to be attached not at the point on a spacer that protrudes furthest but at another point on the protective device.

Pivotal elements secure the seating of the protective device according to the invention on a bicycle in a particularly reliable way.

FIG. 19 shows a plate-like element 191 having a three-part spacer 198 whereof the three parts are designated by the reference numerals 198a, 198b and 198c. As can be seen from FIG. 20, the course of each of the three parts 198 is angled, and they are fixedly connected to the plate-like element 191 in an upper region and can be fixed to the plate-like element in a bottom region which is lower down, optionally at positions 194 at different levels. FIG. 20 shows by means of a dashed line a condition in which the part 198b is fixed to the plate-like element 191 at the highest possible position 194. FIG. 20 shows by means of solid lines a condition in which the part 198b is fixed to the plate-like element 191 at the second lowest possible position 194. Accordingly, the spacing between the tip (where the part 198b is angled) and the plate-like element 191 is greater in the condition illustrated in dashed lines than in the other condition illustrated.

For example, the positions 194 at different levels may be created by slots in the plate-like element 191 into which a projection 195 on the part 198 is pushed. Other constructions are possible, for example supporting the part 198 on a projection on the plate-like element 191, in which case this supporting connection is preferably secured force-fittingly and/or form-fittingly to prevent unintentional release.

FIG. 21 shows, in side view, two rods 179a, 179b which extend downward from a bicycle baggage carrier 180 to a hub 181. A spacer 178 is mounted on the rods 179 respectively by way of a connection region 173a, 173b, such that the spacer 178 is fixed in its current vertical position. However, the vertical position can be adjusted, for example by changing the horizontal spacing between the connection regions 173. With a smaller horizontal spacing, the spacer 178 is fixed at a lower vertical position, and vice versa.

The spacer 178 has a securing region 172 (for example one part of a hook-and-burr closure) on its outwardly facing, approximately planar surface between the connection regions 173. In FIG. 22, which shows a view of the bicycle from the outside, the hidden parts lying behind the plate-like element 171 are illustrated in dashed lines. A second securing region 174 (for example the other part of a hook-and-burr closure) is arranged on the plate-like element 171. Here, the vertical position of the second securing region 174 may preferably be adjusted at least once, for example by gluing the part of the hook-and-burr closure to the inside of the plate-like element 171 at the desired height.

In the mounted condition of the plate-like element 171, the securing regions 172, 174 cooperate with one another such that the plate-like element is secured to the securing region 172 and hence to the spacer 178.

For example, in cross section the spacer 178 has a triangular (as indicated by triangles on its horizontally opposing ends in FIGS. 21 and 22) or another (for example semicircular) profile. On its inside, the spacer 178 is supported against the rods 179 in a manner corresponding to the thickness of the profile.

1. An arrangement for hanging bags from a bicycle (124, 127), in which the arrangement has the following:
at least one plate-like element (61),
securing means (121) for securing the plate-like element (61) to the bicycle (124, 127) such that in a secured condition the plate-like element (61) extends to the side of a wheel (125) of the bicycle (124, 127) from the top downward, and
holding means (5) for hanging a bag from a single hanging point, with the holding means (5) being arranged in the region of the upper end of the plate-like element (61) or above it,
in which the plate-like element (61) is combined with a spacer (128) which is formed out of the latter and/or arranged thereon and which in the secured condition is located on the inner side of the plate-like element (61), that facing the wheel (125), such that an outer surface of the plate-like element (61) on that side of the plate-like element (61) that is opposed to the inner side has a smaller spacing from frame parts (124) of the bicycle (124, 127) in the upper half of the vertical longitudinal extent of the plate-like element (61) than in the lower half, and such that an outer surface of the plate-like element (61) extends from the top downward in a direction that forms an acute angle of at least 5° with the vertical in the secured condition.

2. The arrangement as claimed in the preceding claim, in which the bag (10) is hung from the single hanging point on the holding means (5).

3. The arrangement as claimed in either of the preceding claims, in which the arrangement has two plate-like elements (61a, 61b) which in the secured condition are arranged on mutually opposing sides of the wheel (125).

4. The arrangement as claimed in the preceding claim, in which the holding means (5) are part of a connection device, and in which the two plate-like elements (61) are connected to one another by way of the connection device.

5. The arrangement as claimed in one of the preceding claims, in which the plate-like element (61) is connected to the holding means (5) by way of at least part of the securing means (121).

6. The arrangement as claimed in one of the preceding claims, in which in the secured condition the spacer (128) is located in the lower half of the vertical longitudinal extent of the plate-like element (61).

7. The arrangement as claimed in one of the preceding claims, in which the plate-like element (61) has an approximately planar outer surface which in the secured condition is opposed to the inner side of the plate-like element (61), that facing the wheel (125).

8. The arrangement as claimed in one of the preceding claims, in which the plate-like element (151) has in the region of its upper end a projection (157) which is the holding means or is part of the holding means.

9. The arrangement as claimed in one of the preceding claims, in which the plate-like element (151) has in the region of its upper end a grasping device (153, 154) for grasping a bicycle frame part (165), in which the grasping device (153, 154) is the securing means or part of the securing means.

10. The arrangement as claimed in one of the preceding claims, in which the securing means have an elongate elastic element (63) by means of which the plate-like element (61) is clamped to the frame (69) of the bicycle in the secured condition.

11. The arrangement as claimed in one of the preceding claims, in which the holding means have a securing device which is constructed to secure the holding means to the frame of the bicycle.

12. The arrangement as claimed in one of the preceding claims, in which the holding means have an elastic ring (34) on which at least one respective clamp-like projection (33) is arranged on opposing sides, in which the spacing between the opposing clamp-like projections (33a, 33b) is of a size in a relaxed condition of the elastic ring (34) such that it is smaller than the spacing between two frame parts which are spaced from one another transversely to the longitudinal direction of the bicycle and which extend in the longitudinal direction, and in which the elastic ring (34) is deformable such that the spacing between the opposing projections (33) increases.

13. The arrangement as claimed in one of the preceding claims, in which the plate-like element (61) has a length of at least half the diameter of a 24″ wheel in the vertical direction, that is at least 30.5 cm.

14. The arrangement as claimed in one of the preceding claims, in which the plate-like element (151) has, on a side facing the wheel in the mounted condition, at least one pivotal element (162a, 162b) which is pivotal about an axis of rotation that extends approximately perpendicular to the surface of the plate-like element (151).

15. A method of hanging bags from a bicycle (124, 127), in which:
a plate-like element (61) is secured to the bicycle (124, 127) such that the plate-like element (61) extends to the side of a wheel (125) of the bicycle (124, 127) from the top downward,
the plate-like element (61) is combined with a spacer (128) which is formed out of the latter and/or arranged thereon and which in the secured condition is located on the inner side of the plate-like element (61), that facing the wheel (125), such that an outer surface of the plate-like element (61) on that side of the plate-like element (61) that is opposed to the inner side has a smaller spacing from frame parts (124) of the bicycle (124, 127) in the upper half of the vertical longitudinal extent of the plate-like element (61) than in the lower half, and such that an outer surface of the plate-like element (61) extends from the top downward in a direction that forms an acute angle of at least 5° with the vertical in the secured condition, and
a bag (10) is hung from a single hanging point on the frame of the bicycle (124, 127) such that the bag (10) bears against an outer surface of the plate-like element (61) which is remote from the wheel (125).

16. The method as claimed in the preceding claim, in which two plate-like elements (61) are arranged on mutually opposing sides of the wheel (125) to enable bags (10) to be hung on the opposing sides.

17. The method as claimed in either of the two preceding claims, in which the plate-like element (61) is hung from a load carrier (127) which is arranged above the wheel.

18. The method as claimed in one of the preceding claims, in which the plate-like element (61) is secured to frame parts (124) of the bicycle (124, 127) which are arranged to the side of the wheel (125).

19. The method as claimed in the preceding claim, in which the plate-like element (61) is connected to the frame parts (69) by way of at least one elongate elastic element (63).

20. The method as claimed in one of the preceding claims, in which the plate-like element (61) is arranged to the side of the wheel (125) such that an approximately planar outer surface of the plate-like element (61) whereof the surface normal is directed away from the wheel (125) is increasingly distant from the plane of rotation of the wheel (125) from the top downward.
